(19) United States
(12) Patent Application Publication
(10) Pub. No.: US 2026/0218347 A1
(43) Pub. Date: Jul. 30, 2026

(54) ELECTROMAGNETIC SOFT IRON

(71) Applicant: JFE STEEL CORPORATION, Chiyoda-ku, Tokyo (JP)

(72) Inventors: Yuta IMANAMI, Chiyoda-ku, Tokyo (JP); Katsuyuki ICHIMIYA, Chiyoda-ku, Tokyo (JP)

(73) Assignee: JFE STEEL CORPORATION, Chiyoda-ku, Tokyo (JP)

(21) Appl. No.: 19/145,026

(22) PCT Filed: Jan. 30, 2024
(86) PCT No.: PCT/JP2024/002917

§ 371 Date: Jul. 1, 2025

(30) Foreign Application Priority Data
Feb. 3, 2023 (JP) 2023-015697

(51) Int. Cl. C22C 38/04; C22C 38/00; C22C 38/02; C22C 38/06; C22C 38/08; C22C 38/12; C22C 38/14; C22C 38/16; C22C 38/18; C22C 38/60

(52) U.S. Cl. CPC C22C 38/04; C22C 38/001; C22C 38/002; C22C 38/004; C22C 38/005; C22C 38/008; C22C 38/02; C22C 38/06; C22C 38/08; C22C 38/12; C22C 38/14; C22C 38/16; C22C 38/18; C22C 38/60

(57) ABSTRACT

An electromagnetic soft iron, in particular an electromagnetic soft iron suitable for use in steel bars, that has excellent magnetic properties and excellent machinability by cutting is provided. An electromagnetic soft iron according to the present disclosure contains C: 0.010 mass % or less, Si: 0.010 mass % or less, Mn: 0.10 mass % to 0.50 mass %, P: 0.010 mass % to 0.150 mass %, and S: 0.005 mass % to 0.050 mass %, with the balance being Fe and inevitable impurities.

### TECHNICAL FIELD

The present disclosure relates to electromagnetic soft iron, used in solenoid valves, the iron core of motors, and the like, that has excellent machinability by cutting and magnetic properties.

### BACKGROUND

In recent years, electronic and electromagnetic control components have become increasingly important in line with the demand for more sophisticated vehicle control technology in automobiles and the like. Electromagnetic soft iron with excellent magnetic properties is used in solenoid valves for controlling hydraulic pressure and the like in order to achieve quick and stable setting of the hydraulic pressure and the like.

Since these components are formed mainly by cutting, sufficient machinability by cutting is also required.

For example, Patent Literature (PTL) 1 proposes a soft magnetic low-carbon steel material with excellent machinability by cutting and magnetic properties by controlling the ferrite crystal grain size, the mass ratio of Mn to S, and the dispersion state of MnS.

PTL 2 proposes a soft magnetic steel material with improved strength and machinability by cutting, without a deterioration in magnetic properties, by controlling the crystal grain size number of ferrite and the dispersion state of carbonitrides.

### CITATION LIST

### Patent Literature

PTL 1: JP 2003-55745 A
PTL 2: JP 6262599 B2

### SUMMARY

### Technical Problem

In recent years, however, momentum for electronic and electrified automobiles and the like has grown, and in order to improve the performance of electronic and electromagnetic control parts, their shapes have become more complex and their dimensions have become more precise, requiring electromagnetic soft iron to have even better machinability by cutting than before. However, the technologies for controlling ferrite crystal grain size and MnS dispersion described in PTL 1 and 2 have the problem that the machinability by cutting of the resulting steel material is insufficient.

It is an aim of the present disclosure, conceived in light of the above circumstances, to provide an electromagnetic soft iron, in particular an electromagnetic soft iron suitable for use in steel bars, that has excellent magnetic properties and machinability by cutting.

### Solution to Problem

To achieve the aforementioned aim, we studied the effects of alloying elements on machinability by cutting and magnetic properties. As a result, we discovered that the addition of P improves machinability by cutting without impairing magnetic properties in the case of use in electromagnetic soft iron, especially an electromagnetic soft iron steel bar.

Based on these discoveries, we conducted further observations which eventually led to the present disclosure.

We provide the following.
1. An electromagnetic soft iron comprising a chemical composition containing (consisting of) C: 0.010 mass % or less, Si: 0.010 mass % or less, Mn: 0.10 mass % to 0.50 mass %, P: 0.010 mass % to 0.150 mass %, and S: 0.005 mass % to 0.050 mass %, with the balance being Fe and inevitable impurities.
2. The electromagnetic soft iron according to 1., wherein the chemical composition further contains (consists of) one or more selected from the group consisting of one or more of groups A to E,
group A: B: 0.0100 mass % or less, Se: 0.300 mass % or less, Ca: 0.0500 mass % or less, Pb: 0.300 mass % or less, Bi: 0.300 mass % or less, Mg: 0.0500 mass % or less, Zr: 0.2000 mass % or less, REM: 0.010 mass % or less, and O: 0.0250 mass % or less,
group B: Cr: 2.0 mass % or less, Mo: 1.00 mass % or less, Cu: 1.0 mass % or less, Ni: 1.0 mass % or less, Ti: 0.10 mass % or less, Nb: 0.10 mass % or less, and V: 0.3 mass % or less,
group C: Sn: 0.1000 mass % or less, and Sb: 0.0100 mass % or less,
group D: Al: 0.0300 mass % or less,
group E: N: 0.0100 mass % or less.

### Advantageous Effect

According to the present disclosure, it is possible to provide an electromagnetic soft iron, in particular an electromagnetic soft iron suitable for use in steel bars, that has excellent magnetic properties and machinability by cutting.

### BRIEF DESCRIPTION OF THE DRAWINGS

In the accompanying drawings:

FIG. 1 is a schematic diagram illustrating the flank wear width (Vb) of a tool in the present example.

### DETAILED DESCRIPTION

The present disclosure is described in detail below.

First, the basic components of the electromagnetic soft iron of the present disclosure are described.

### C: 0.010 Mass % or Less

If the C content exceeds 0.010 mass %, iron loss worsens due to magnetic aging. Therefore, the C content is limited to 0.010 mass % or less. On the other hand, no lower limit is placed on the C content, but the C content is preferably 0.001 mass % or more to suppress an increase in refining costs.

### Si: 0.010 Mass % or Less

Si is effective as a deoxidizer, but in excess of 0.010 mass %, Si reduces workability. Therefore, the Si content is limited to 0.010 mass % or less. The Si content is preferably 0.005 mass % or less, and more preferably 0.003 mass % or less. On the other hand, no lower limit is placed on the Si content, but the Si content is preferably 0.001 mass % or more, since excessive reduction leads to increased refining costs.

### Mn: 0.10 Mass % to 0.50 Mass %

Mn is an element that combines with S to form sulfides, thereby improving machinability by cutting. To achieve this effect, at least 0.10 mass % of Mn must be added. The Mn content is preferably 0.15 mass % or more, and more preferably 0.20 mass % or more. On the other hand, excessive addition of Mn degrades magnetic properties. The upper limit of the Mn content is therefore set to 0.50 mass %. The Mn content is preferably 0.40 mass % or less, and more preferably 0.35 mass % or less.

### P: 0.010 Mass % to 0.150 Mass %

P has the effect of improving machinability by cutting. To obtain this effect, P needs to be added in an amount of at least 0.010 mass %. On the other hand, adding more than 0.150 mass % saturates the effect of improving machinability by cutting. Therefore, the P content is limited to a range of 0.010 mass % to 0.150 mass %. The P content is preferably 0.020 mass % or more, and more preferably 0.031 mass % or more. The P content is preferably 0.100 mass % or less, and more preferably 0.085 mass % or less.

### S: 0.005 Mass % to 0.050 Mass %

S is an element that exists as sulfide inclusions and is effective in improving machinability by cutting. To obtain this effect, S needs to be added in an amount of at least 0.005 mass %. On the other hand, adding more than 0.050 mass % decreases the hot workability of the steel and increases surface cracking during continuous casting. Therefore, the S content is limited to a range of 0.005 mass % to 0.050 mass %. The S content is preferably 0.010 mass % or more, and more preferably 0.015 mass % or more. The S content is even more preferably 0.021 mass % or more. The S content is preferably 0.040 mass % or less, and more preferably 0.035 mass % or less.

Although the basic components of the present disclosure are as described above, one or more components (elements) selected from the group consisting of one or more of groups A to E below may be further included as necessary in the present disclosure. The balance is Fe and inevitable impurities in all cases. Inevitable impurities are introduced from ore and scrap as raw materials, from the production environment, and the like during the industrial production of steel material and are allowed to the extent that they do not adversely affect the characteristics of the present embodiment.

Group A: B: 0.0100 mass % or less, Se: 0.300 mass % or less, Ca: 0.0500 mass % or less, Pb: 0.300 mass % or less, Bi: 0.300 mass % or less, Mg: 0.0500 mass % or less, Zr: 0.2000 mass % or less, REM: 0.010 mass % or less, and O: 0.0250 mass % or less

### B: 0.0100 Mass % or Less

B combines with N to form nitrides, thereby improving machinability by cutting. However, the upper limit of the B content is preferably 0.0100 mass %, since exceeding 0.0100 mass % may degrade the magnetic properties. The B content is more preferably 0.0050 mass % or less, and even more preferably 0.0030 mass % or less. On the other hand, while no lower limit is placed on the B content, the B content is preferably 0.0005 mass % or more, and more preferably 0.0010 mass % or more.

### Se: 0.300 Mass % or Less

Se combines with Mn to form Se compounds, thereby improving machinability by cutting. However, the upper limit of the Se content is preferably 0.300 mass %, since exceeding 0.300 mass % may degrade the magnetic properties. The Se content is more preferably 0.100 mass % or less, and even more preferably 0.070 mass % or less. On the other hand, while no lower limit is placed on the Se content, the Se content is preferably 0.001 mass % or more, and more preferably 0.005 mass % or more.

### Ca: 0.0500 Mass % or Less

Ca combines with S to form sulfides, thereby improving machinability by cutting. However, the upper limit of the Ca content is preferably 0.0500 mass %, since exceeding 0.0500 mass % may degrade the magnetic properties. The Ca content is more preferably 0.0300 mass % or less, and even more preferably 0.0150 mass % or less. On the other hand, while no lower limit is placed on the Ca content, the Ca content is preferably 0.0005 mass % or more, and more preferably 0.0010 mass % or more.

### Pb: 0.300 Mass % or Less, Bi: 0.300 Mass % or Less

Pb and Bi improve machinability by cutting, through an effect of refining chips during cutting. However, since excessive addition only saturates the effect, the upper limit of each of the Pb content and Bi content is preferably 0.300 mass %. The content of each is more preferably 0.250 mass % or less, and even more preferably 0.150 mass % or less. On the other hand, while no lower limit is placed on the Pb content and Bi content, the content of each is preferably 0.005 mass % or more, and more preferably 0.010 mass % or more.

### Mg: 0.0500 Mass % or Less

Mg improves machinability by cutting, but if the content exceeds 0.0500 mass %, there is a risk of degradation in magnetic properties. Therefore, the upper limit of the Mg content is preferably 0.0500 mass %. The Mg content is more preferably 0.0300 mass % or less, and even more preferably 0.0150 mass % or less. On the other hand, while no lower limit is placed on the Mg content, the Mg content is preferably 0.0010 mass % or more, and more preferably 0.0030 mass % or more.

### Zr: 0.2000 Mass % or Less

Zr improves machinability by cutting, but if the content exceeds 0.2000 mass %, there is a risk of degradation in magnetic properties. Therefore, the upper limit of the Zr content is preferably 0.2000 mass %. The Zr content is more preferably 0.1000 mass % or less, and even more preferably 0.0500 mass % or less. On the other hand, while no lower limit is placed on the Zr content, the Zr content is preferably 0.0010 mass % or more, and more preferably 0.0030 mass % or more.

### REM: 0.010 Mass % or Less

REM improve machinability by cutting, but if the content exceeds 0.010 mass %, there is a risk of degradation in magnetic properties. Therefore, the upper limit of the REM content is preferably 0.010 mass %. The REM content is more preferably 0.005 mass % or less, and even more preferably 0.004 mass % or less. On the other hand, while no lower limit is placed on the REM content, the REM content is preferably 0.001 mass % or more, and more preferably 0.002 mass % or more.

### O: 0.0250 Mass % or Less

O (oxygen) improves machinability by cutting, through its effect of coarsening sulfide inclusions, but excessive addition may cause a decrease in the toughness of steel material, leading to premature fracture of structural members. Therefore, the upper limit of the O content is preferably 0.0250 mass %. The O content is more preferably 0.0230 mass % or less, and even more preferably 0.0200 mass % or less. On the other hand, while no lower limit is placed on the O content, the O content is preferably 0.0010 mass % or more, and more preferably 0.0050 mass % or more.

### Group B: Cr: 2.0 Mass % or Less, Mo: 1.00 Mass % or Less, Cu: 1.0 Mass % or Less, Ni: 1.0 Mass % or Less, Ti: 0.10 Mass % or Less, Nb: 0.10 Mass % or Less, and V: 0.3 Mass % or Less

Cr, Mo, Cu, Ni, Ti, Nb, and V contribute to enhancing the strength of steel through solid solution strengthening and strengthening by precipitation. Although these elements may be added to adjust the strength in accordance with the required properties of the components, excessive addition will only saturate the effect. Therefore, the upper limits are preferably set to the aforementioned numerical values. On the other hand, the lower limits of the Cr, Mo, Cu, Ni, Ti, Nb, and V contents are not particularly limited and may each be 0 mass %.

### Group C: Sb: 0.0100 Mass % or Less, and Sn: 0.1000 Mass % or Less Sb: 0.0100 Mass % or Less, Sn: 0.1000 Mass % or Less

Sb and Sn each have an effect of improving descalability during shot blasting and pickling performed before cold wiredrawing, and may be added as necessary in a case in which these processes are included during component production. However, the effect of improving descalability will be saturated if Sb and Sn are added in excess of 0.0100 mass % and 0.1000 mass %, respectively. Therefore, the upper limits on the Sb content and Sn content are preferably 0.0100 mass % and 0.1000 mass %, respectively. On the other hand, no lower limits are placed on the Sb content and Sn content, and the content of either may be 0.0010 mass %.

### Group D: Al: 0.0300 Mass % or Less

### Al: 0.0300 Mass % or Less

Al combines with N to form fine nitrides, thereby refining the crystal grain size and degrading the magnetic properties. To eliminate this adverse effect insofar as possible, the Al content is preferably reduced to 0.0300 mass % or less. The Al content is more preferably 0.0015 mass % or less, and even more preferably 0.0010 mass % or less. On the other hand, no lower limit is placed on the Al content, which may be 0 mass %.

In the present disclosure, the Al content can be regarded as part of the aforementioned unavoidable impurities, up to about 0.0015 mass %.

### Group E: N: 0.0100 Mass % or Less

### N: 0.0100 Mass % or Less

N degrades the magnetic properties over time through the aging effect due to solute N. To eliminate this adverse effect insofar as possible, the N content is preferably reduced to 0.0100 mass % or less. The N content is more preferably 0.0050 mass % or less, and even more preferably 0.0040 mass % or less. On the other hand, no lower limit is placed on the N content, which may be 0 mass %.

In the present disclosure, the N content can be regarded as part of the aforementioned unavoidable impurities, up to about 0.0050 mass %.

In the electromagnetic soft iron (electromagnetic soft iron steel bar) and the production method thereof according to the present disclosure, all items not described in the present specification can be in accordance with known electromagnetic soft iron and electromagnetic soft iron steel bars and conventional methods.

An example is a production method of melting steel having the above-described chemical composition by continuous casting, then hot rolling at a heating temperature in the range of 950° C. to 1250° C., subsequently air cooling, and then hot rolling again at a heating temperature in the range of 950° C. to 1250° C. to form the material into a specified shape, such as a round bar. This makes it possible to obtain an electromagnetic soft iron, in particular an electromagnetic soft iron suitable for use in steel bars that are often machined into parts by cutting, that has excellent magnetic properties and machinability by cutting. The present disclosure is particularly suitable for steel material that is processed into parts by cutting, but the shape is not limited to steel bars and may also be steel sheets or the like.

### Examples

The following describes the structures and function effects of the present disclosure in more detail, by way of examples. However, the present disclosure is not restricted by any means to these examples, which may be changed appropriately within a range conforming to the spirit of the present disclosure, all such changes being included within the technical scope of the present disclosure.

Steels having the respective chemical compositions listed in Table 1 were each obtained by steelmaking and formed into a round bar with a diameter of 25 mm by hot rolling. The resulting round bars were evaluated for magnetic properties and machinability by cutting by the following methods.

TABLE 1

| | C | Si | Mn | P | S | Al | N | Others | |
|---|---|---|---|---|---|---|---|---|---|
| No. | (mass %) | (mass %) | (mass %) | (mass %) | (mass %) | (mass %) | (mass %) | (mass %) | Notes |
| 1 | 0.002 | 0.008 | 0.37 | 0.053 | 0.006 | 0.0011 | 0.0015 | — | Conforming |
| 2 | 0.006 | 0.008 | 0.35 | 0.024 | 0.046 | 0.0284 | 0.0081 | — | steel |
| 3 | 0.003 | 0.005 | 0.29 | 0.011 | 0.040 | 0.0282 | 0.0093 | — | |
| 4 | 0.001 | 0.009 | 0.21 | 0.043 | 0.024 | 0.0291 | 0.0088 | — | |
| 5 | 0.007 | 0.007 | 0.18 | 0.130 | 0.022 | 0.0088 | 0.0093 | — | |
| 6 | 0.007 | 0.005 | 0.20 | 0.136 | 0.007 | 0.0185 | 0.0083 | — | |
| 7 | 0.003 | 0.006 | 0.43 | 0.013 | 0.023 | 0.0146 | 0.0078 | — | |
| 8 | 0.007 | 0.007 | 0.37 | 0.063 | 0.045 | 0.0063 | 0.0058 | — | |
| 9 | 0.006 | 0.009 | 0.26 | 0.025 | 0.031 | 0.0240 | 0.0082 | — | |
| 10 | 0.009 | 0.008 | 0.17 | 0.064 | 0.036 | 0.0252 | 0.0074 | — | |
| 11 | 0.003 | 0.008 | 0.45 | 0.043 | 0.027 | 0.0232 | 0.0066 | B: 0.0025 | |
| 12 | 0.004 | 0.008 | 0.40 | 0.021 | 0.011 | 0.0175 | 0.0087 | Se: 0.007 | |
| 13 | 0.008 | 0.006 | 0.10 | 0.056 | 0.012 | 0.0110 | 0.0085 | Ca: 0.0019 | |
| 14 | 0.009 | 0.006 | 0.35 | 0.073 | 0.022 | 0.0139 | 0.0063 | Pb: 0.090 | |
| 15 | 0.008 | 0.004 | 0.33 | 0.030 | 0.039 | 0.0240 | 0.0083 | Bi: 0.090 | |
| 16 | 0.005 | 0.005 | 0.18 | 0.124 | 0.022 | 0.0129 | 0.0086 | Mg: 0.0035 | |
| 17 | 0.007 | 0.005 | 0.23 | 0.045 | 0.030 | 0.0299 | 0.0051 | Zr: 0.0041 | |
| 18 | 0.002 | 0.004 | 0.43 | 0.090 | 0.026 | 0.0222 | 0.0098 | REM: 0.003 | |
| 19 | 0.008 | 0.005 | 0.39 | 0.105 | 0.012 | 0.0092 | 0.0084 | O: 0.0181 | |
| 20 | 0.004 | 0.004 | 0.18 | 0.108 | 0.029 | 0.0138 | 0.0098 | Cr: 1.5 | |
| 21 | 0.009 | 0.004 | 0.19 | 0.147 | 0.049 | 0.0013 | 0.0021 | Mo: 0.35 | |
| 22 | 0.005 | 0.007 | 0.46 | 0.081 | 0.006 | 0.0254 | 0.0078 | Cu: 0.5 | |
| 23 | 0.001 | 0.003 | 0.23 | 0.148 | 0.028 | 0.0152 | 0.0063 | Ni: 0.5 | |
| 24 | 0.006 | 0.010 | 0.22 | 0.094 | 0.046 | 0.0012 | 0.0009 | Ti: 0.05 | |
| 25 | 0.001 | 0.007 | 0.36 | 0.096 | 0.007 | 0.0152 | 0.0078 | Nb: 0.06 | |
| 26 | 0.009 | 0.004 | 0.16 | 0.028 | 0.017 | 0.0141 | 0.0086 | V: 0.3 | |
| 27 | 0.009 | 0.010 | 0.12 | 0.136 | 0.019 | 0.0104 | 0.0084 | Sn: 0.0300 | |
| 28 | 0.009 | 0.005 | 0.20 | 0.073 | 0.029 | 0.0186 | 0.0067 | Sb: 0.0025 | |
| 29 | 0.008 | 0.006 | 0.30 | 0.146 | 0.035 | 0.0009 | 0.0049 | — | |
| 30 | 0.009 | 0.008 | 0.33 | 0.026 | 0.041 | 0.0015 | 0.0038 | — | |
| 31 | 0.012 | 0.006 | 0.35 | 0.082 | 0.010 | 0.0273 | 0.0089 | — | Comparative |
| 32 | 0.006 | 0.011 | 0.41 | 0.085 | 0.036 | 0.0081 | 0.0059 | — | steel |
| 33 | 0.008 | 0.006 | 0.08 | 0.113 | 0.040 | 0.0257 | 0.0063 | — | |
| 34 | 0.003 | 0.008 | 0.60 | 0.095 | 0.045 | 0.0038 | 0.0080 | — | |
| 35 | 0.009 | 0.004 | 0.37 | 0.008 | 0.017 | 0.0060 | 0.0073 | — | |
| 36 | 0.008 | 0.007 | 0.11 | 0.005 | 0.013 | 0.0261 | 0.0058 | — | |
| 37 | 0.009 | 0.009 | 0.29 | 0.052 | 0.004 | 0.0229 | 0.0057 | — | |

Note:
the balance of the chemical composition is Fe and inevitable impurities.

The magnetic properties were measured in accordance with JIS C2504. Ring test pieces were sampled from the aforementioned round bars, and the ring test pieces were annealed at 750° C. for 2 hours. An excitation winding (primary winding 220 turns) and a detection winding (secondary winding 100 turns) were subsequently provided to the ring test pieces.

The B-H curve was measured using a DC magnetizing measurement device to evaluate the magnetic flux density at 100 A/m and 300 A/m during a magnetization process with a highest attainable magnetic field of 10000 A/m. In the present test, the magnetic properties are considered excellent if the magnetic flux densities are 1.20 T and 1.50 T or more, respectively.

Similarly, the coercivity was measured and evaluated at a reversal magnetization force of ±400 A/m, using a DC magnetic property test apparatus. In the present test, a coercivity of 60 A/m or less is considered to represent excellent magnetic properties.

Next, a cutting test was conducted under the set of conditions illustrated in Table 2, and the machinability by cutting was evaluated by comparing tool life, surface roughness during cutting, and chip shape.

TABLE 2

| | |
|---|---|
| Method | Outer periphery lathe turning |
| Lathe turning insert material | PVD-coated carbide |
| Cutting speed | 150 m/min |
| Feed rate | 0.15 mm/rev |
| Cutting depth | 0.2 mm |
| Lubricant | Water-soluble cutting oil |
| | (emulsion, 10% dilution) |

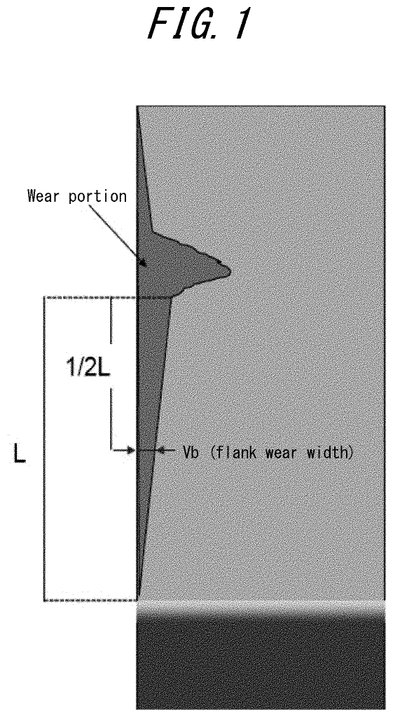

The tool life was evaluated by the flank wear width of the tool after cutting the resulting round bar 5 m in the longitudinal direction. The flank wear width is the flank wear width (Vb) of the average wear portion, not the boundary wear portion, as illustrated in FIG. 1. Under the set of conditions of the present Examples, the tool life is considered excellent if the flank average wear width is 200 μm or less.

The surface roughness during cutting was evaluated as follows: the resulting round bar was cut 1 m in the longitudinal direction, the ten-point average roughness Rz (JIS B 0601) was measured by a stylus-type roughness meter with a reference length of 4 mm, and the surface roughness was evaluated based on the magnitude of Rz. Under the set of conditions of the present Examples, good quality parts can be considered produceable if the surface roughness Rz is 25 μm or less.

The evaluation of chip shape was based on whether a chip ring with three or more turns was formed in the chips generated during cutting in the aforementioned surface roughness evaluation test. If no chip ring with three or more turns is generated, the chips are finely broken up, and the round bar can be considered excellent in terms of chip processability.

Table 3 summarizes the evaluation results of the magnetic properties and the machinability by cutting. When the No. in Table 1 and the No. in Table 3 are the same, it means that the same steel material is used. For example, the composition of the round bar whose evaluation results are indicated in No. 1 of Table 3 is the composition indicated in No. 1 of Table 1. In Table 3, ⊚ means that the aforementioned chip ring has less than one turn, ◯ means that the aforementioned chip ring has one or more turns and less than three turns, and X means that the aforementioned chip ring has three or more turns.

TABLE 3

| | | | | Machinability by cutting | | | |
|---|---|---|---|---|---|---|---|
| | | | | Flank | Surface | | |
| | Magnetic flux density | | | wear | roughness | | |
| | T | T | Coercivity | width | Rz | Chip | |
| No. | (100 A/m) | (300 A/m) | (A/m) | (μm) | (μm) | shape | Notes |
| 1 | 1.21 | 1.52 | 56 | 110 | 21 | ◯ | Example |
| 2 | 1.27 | 1.52 | 49 | 149 | 20 | ◯ | |
| 3 | 1.25 | 1.57 | 46 | 156 | 17 | ◯ | |
| 4 | 1.25 | 1.53 | 54 | 107 | 14 | ◯ | |
| 5 | 1.24 | 1.55 | 49 | 71 | 8 | ◯ | |
| 6 | 1.25 | 1.53 | 45 | 56 | 12 | ◯ | |
| 7 | 1.21 | 1.53 | 53 | 184 | 21 | ◯ | |
| 8 | 1.25 | 1.58 | 47 | 95 | 10 | ◯ | |
| 9 | 1.20 | 1.56 | 54 | 171 | 24 | ◯ | |
| 10 | 1.28 | 1.57 | 54 | 122 | 21 | ◯ | |
| 11 | 1.24 | 1.59 | 52 | 97 | 10 | ⊚ | |
| 12 | 1.29 | 1.54 | 55 | 157 | 21 | ⊚ | |
| 13 | 1.28 | 1.51 | 56 | 116 | 15 | ⊚ | |
| 14 | 1.28 | 1.51 | 56 | 86 | 17 | ⊚ | |
| 15 | 1.21 | 1.58 | 53 | 154 | 16 | ⊚ | |
| 16 | 1.21 | 1.53 | 50 | 70 | 15 | ⊚ | |
| 17 | 1.24 | 1.56 | 56 | 119 | 21 | ⊚ | |
| 18 | 1.24 | 1.52 | 60 | 78 | 17 | ⊚ | |
| 19 | 1.26 | 1.52 | 51 | 71 | 10 | ⊚ | |
| 20 | 1.26 | 1.55 | 59 | 73 | 8 | ◯ | |
| 21 | 1.24 | 1.59 | 47 | 72 | 14 | ◯ | |
| 22 | 1.21 | 1.59 | 45 | 101 | 18 | ◯ | |
| 23 | 1.27 | 1.54 | 52 | 80 | 11 | ◯ | |
| 24 | 1.26 | 1.54 | 57 | 72 | 9 | ◯ | |
| 25 | 1.28 | 1.59 | 55 | 77 | 11 | ◯ | |
| 26 | 1.28 | 1.58 | 49 | 168 | 24 | ◯ | |
| 27 | 1.28 | 1.58 | 45 | 54 | 9 | ◯ | |
| 28 | 1.26 | 1.54 | 50 | 106 | 20 | ◯ | |
| 29 | 1.28 | 1.55 | 48 | 65 | 15 | ◯ | |
| 30 | 1.20 | 1.55 | 57 | 163 | 18 | ◯ | |
| 31 | 1.15 | 1.41 | 65 | 107 | 14 | ◯ | Comparative |
| 32 | 1.23 | 1.53 | 50 | 119 | 14 | X | Example |
| 33 | 1.22 | 1.58 | 51 | 110 | 14 | X | |
| 34 | 1.12 | 1.44 | 62 | 95 | 14 | ◯ | |
| 35 | 1.24 | 1.56 | 48 | 245 | 30 | X | |
| 36 | 1.22 | 1.54 | 53 | 267 | 31 | X | |
| 37 | 1.27 | 1.50 | 55 | 132 | 15 | X | |

⊚: Less than 1 turn
◯: 1 turn or more and less than 3 turns
X: 3 or more turns

As illustrated in Table 3, it is clear that all of the Examples according to the present disclosure have excellent magnetic properties and excellent machinability by cutting.

In contrast, either or both of the magnetic properties and the machinability by cutting was inferior in the Comparative Examples that deviated from the present disclosure.

1. An electromagnetic soft iron comprising:
a chemical composition containing
C: 0.010 mass % or less,
Si: 0.010 mass % or less,
Mn: 0.10 mass % to 0.50 mass %,
P: 0.010 mass % to 0.150 mass %, and
S: 0.005 mass % to 0.050 mass %,
with the balance being Fe and inevitable impurities.

2. The electromagnetic soft iron according to claim 1, wherein the chemical composition further contains one or more selected from the group consisting of one or more of groups A to E,
group A:
B: 0.0100 mass % or less,
Se: 0.300 mass % or less,
Ca: 0.0500 mass % or less,
Pb: 0.300 mass % or less,
Bi: 0.300 mass % or less,
Mg: 0.0500 mass % or less,
Zr: 0.2000 mass % or less,
REM: 0.010 mass % or less, and
O: 0.0250 mass % or less,
group B:
Cr: 2.0 mass % or less,
Mo: 1.00 mass % or less,
Cu: 1.0 mass % or less,
Ni: 1.0 mass % or less,
Ti: 0.10 mass % or less,
Nb: 0.10 mass % or less, and
V: 0.3 mass % or less,
group C:
Sn: 0.1000 mass % or less, and
Sb: 0.0100 mass % or less,
group D:
Al: 0.0300 mass % or less,
group E:
N: 0.0100 mass % or less.
